(19) United States
(12) Patent Application Publication
(10) Pub. No.: US 2020/0269670 A1
(43) Pub. Date: Aug. 27, 2020

(54) VEHICLE PROTECTION AGAINST WEATHER AND TEMPERATURE SYSTEM AND COMPONENTS THEREOF

(71) Applicants: Kevin McDaniel, Glenmore, LA (US); Joseph Soreo, Glenmore, LA (US)

(72) Inventors: Kevin McDaniel, Glenmore, LA (US); Joseph Soreo, Glenmore, LA (US)

(21) Appl. No.: 16/281,322

(22) Filed: Feb. 21, 2019

(51) Int. Cl. B60J 11/02; B60J 11/04

(52) U.S. Cl. CPC B60J 11/025; B60J 11/04

(57) ABSTRACT

A vehicle protection system to protect a vehicle from weather and temperature, the vehicle protection system including a slide-out cover to at least partially expose the window in a first position and to at least partially cover a window of the vehicle in a second position, a rain bag to collect and direct water away from the window, and a roof protector to at least partially expose the roof in a first lateral position and to at least partially cover a roof in a second lateral position. The vehicle protection system may further include a control unit to control at least one of the slide-out cover and the roof protector.

### BACKGROUND

### 1. Field

The present general inventive concept relates generally to a vehicle protection system, and particularly, to a vehicle protection against weather and temperature system, and components thereof.

### 2. Description of the Related Art

A recreational vehicle (RV) is a motor vehicle that includes living accommodations, such as a kitchen, a bathroom, and a bedroom. RVs vary in size, but are typically larger than a car, a van, a sport utility vehicle (SUV) and a pickup truck, but are similar in size to a semi-trailer truck.

One of the major advantages of having an RV is that it offers a roof over an owner's head while on the road. It is necessary to keep all exterior surfaces well maintained as time goes by to prevent cracks, aging signs, and deterioration.

Therefore, there is a need for a system to protect an RV from potential damage from weather and temperature that will cause damage to the RV.

### SUMMARY

The present general inventive concept provides a vehicle protection against weather and temperature system, and components thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a slide-out cover, including a cover mat removably connected to a portion of a wall surrounding a window of a vehicle to at least partially expose the window in a first position and to at least partially cover the window in a second position, and at least one rod to support the cover mat.

The over mat may insulate an interior portion of the vehicle by preventing at least one of cold air and hot air from reaching the interior portion of the vehicle.

The cover mat may prevent UV radiation from reaching the interior portion of the vehicle.

The foregoing and/or other features and utilities of the present general inventive concept may also be achieved by providing a roof protector may include a spring-loaded roller removably connected to a portion of a roof of a vehicle, and a roof-protection mat disposed within the spring-loaded roller to at least partially expose the roof in a first position and to at least partially cover the roof in a second position.

The roof protector may further include a front guard disposed within the spring-loaded roller to at least partially expose the front of the vehicle in a first position and to at least partially cover a front of the vehicle in a second position.

The roof protector may further include at least one roof boot to cover at least one of an AC unit and a skylight.

The foregoing and/or other features and utilities of the present general inventive concept may also be achieved by providing a vehicle protection system to protect a vehicle from weather and temperature, the vehicle protection system including a slide-out cover to at least partially expose the window in a first position and to at least partially cover a window of the vehicle in a second position, a rain bag to collect and direct water away from the window, and a roof protector to at least partially expose the roof in a first lateral position and to at least partially cover a roof in a second lateral position.

The vehicle protection system may further include a control unit to control at least one of the slide-out cover and the roof protector.

The slide-out cover may include a slide-out cover motor to rotate in response to a command from the control unit, such that the slide-out cover moves in response to the rotation of slide-out cover motor.

The roof protector may include a roof protector motor to rotate in response to a command from the control unit, such that the roof protector moves in response to the rotation of the roof protector motor.

The vehicle protection system may further include a sensor to detect a reading of at least one of a temperature level, a UV radiation level, and a precipitation level, such that the control unit compares the detected reading to a predetermined threshold.

The control unit may send a command to the slide-out cover based on the comparison.

The slide-out cover may move in response to the command from the control unit.

The control unit may send another command to the roof protector based on the comparison.

The roof protector may move in response to the another command from the control unit.

The rain bag may include a water-collecting surface to collect and direct water away from a window of the vehicle, and a drain hose disposed on a portion of the water-collecting surface to drain water from the water-collecting surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a side view of a slide-out cover as disposed around a window on at least a portion of an RV and a rain bag as disposed under a portion of the window of the RV, according to an exemplary embodiment of the present general inventive concept;

FIG. 1B illustrates a zoomed in side angled view of the slide-out cover as disposed around the window on at least a portion of the RV, according to an exemplary embodiment of the present general inventive concept; and

FIG. 2 illustrates a top view of a roof protector as disposed on a top surface of the RV in an extended position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Vehicle Protection Against Weather and Temperature System 100

Slide-Out Cover 110

Cover Mat 111

Slide-Out Cover Motor 112

Belt 113

At Least One Rod 114

Plurality of Fasteners 115

Rain Bag 120

Water-Collecting Surface 121

Draining Aperture 121a

Connecting Portion 121b

Drain Hose 122

Roof Protector 130

Front Guard 131

Spring-Loaded Roller 132

Roof-Protection Mat 133

At Least One Roof Boot 134

Roof Protector Motor 135

Belt 136

Plurality of Fasteners 137

Control Unit 140

Input Unit 141

Display Unit 142

Processor 143

Communication Unit 144

Storage Unit 145

Sensor 150

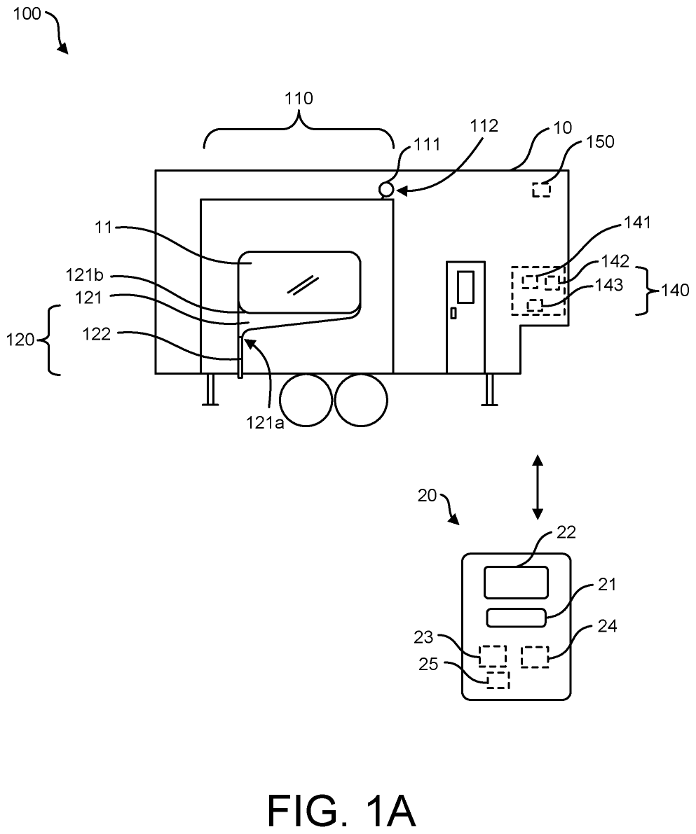

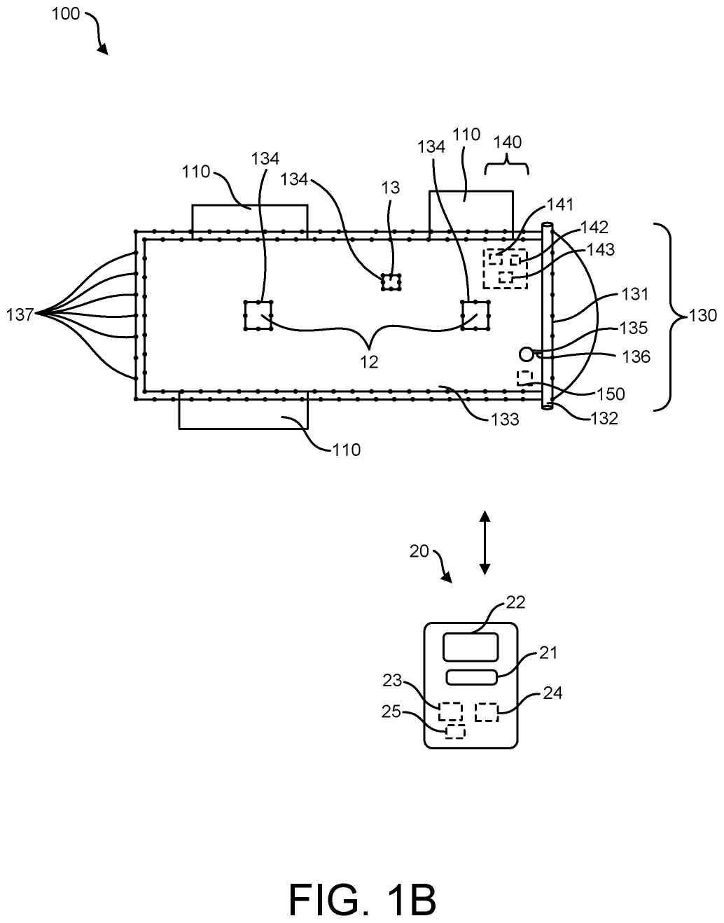

FIG. 1A illustrates a side view of a slide-out cover 110 as disposed around a window 11 on at least a portion of an RV 10 and a rain bag 120 as disposed under a portion of the window 11 of the RV 10, according to an exemplary embodiment of the present general inventive concept.

FIG. 1B illustrates a zoomed in side angled view of the slide-out cover 110 as disposed around the window 11 on at least a portion of the RV 10, according to an exemplary embodiment of the present general inventive concept.

The vehicle protection against weather and temperature system 100 (for the sake of brevity, it will hereafter be referred to as the vehicle protection system 100) may be constructed from at least one of canvas, metal, plastic, wood, neoprene, and other rubbers, etc., but is not limited thereto.

The vehicle protection system 100 may include the slide-out cover 110, the rain bag 120, a roof protector 130, a control unit 140, and a sensor 150, but is not limited thereto.

Referring to FIGS. 1A and 1B, the slide-out cover 110 may include a cover mat 111, a slide-out cover motor 112, a belt 113, at least one rod 114, and a plurality of fasteners 115, but is not limited thereto.

The cover mat 111 may be constructed from a strong, flexible material. For example, the cover mat 111 may be constructed from neoprene, but is not limited thereto.

The cover mat 111 may be of any predetermined size to substantially cover at least a portion of the window 11 of the RV 10. As such, the cover mat 111 may be a one-size fits all design. Alternatively, the cover mat 111 may be constructed for specific sizes of the window 11. The cover mat 111 may be at least partially extended in a first lateral direction or a second lateral direction from a first position (i.e. retracted) to a second position (i.e. extended) to at least partially cover a portion of the window 11. Moreover, the at least one rod 114 may be moved in the first lateral direction or the second lateral direction to support the cover mat 111 in the extended position. Also, the cover mat 111 may be at least partially retracted in the second lateral direction or the first lateral direction from the second position to the first position. Additionally, the cover may 111 may extend in response to any partial movement of a portion of a wall around the window 11 from and/or toward the RV 10.

The cover mat 111 may protect a window 11 from inclement weather when the cover mat 111 is at least partially extended away from the wall around the window 11, such as rain, snow, sleet, hail, etc., but is not limited thereto. Furthermore, the cover mat 111 may insulate an interior portion of the RV 10 by preventing cold air and/or hot air from reaching the interior portion of the RV 10. Moreover, the cover mat 111 may prevent ultraviolet (UV) radiation from reaching the interior portion of the RV 10.

The plurality of fasteners 115 may include a soldered joint, a glued joint, a screw, a nail, a bolt, a nut, a washer, and/or any combination thereof, but is not limited thereto.

The cover mat 111 may be removably connected to the portion of the wall around window 11 using the plurality of fasteners 115.

Referring to FIG. 1A, the rain bag 120 may include a water-collecting surface 121, a draining aperture 121a, a connecting portion 121b, and a drain hose 122, but is not limited thereto.

The rain bag 120 may be removably connected to at least a bottom edge of the window 11 of the RV 10. Specifically, the rain bag 120 may be affixed and/or adhered at the connecting portion 121b. The water-collecting surface 121 may collect and direct water away from the window 11 and any exposed portions of the wall around the window 11 that may lead to an interior portion of the RV 10. The drain hose 122 may be disposed on at least a portion of the water-collecting surface 122. The water-collecting surface 121 may be oriented toward a ground surface, such that water in contact with the water-collecting surface 121 may flow toward the draining aperture 121 and exits out an end of the drain hose 122. In other words, the drain hose 122 may drain water from the water-collecting surface 121.

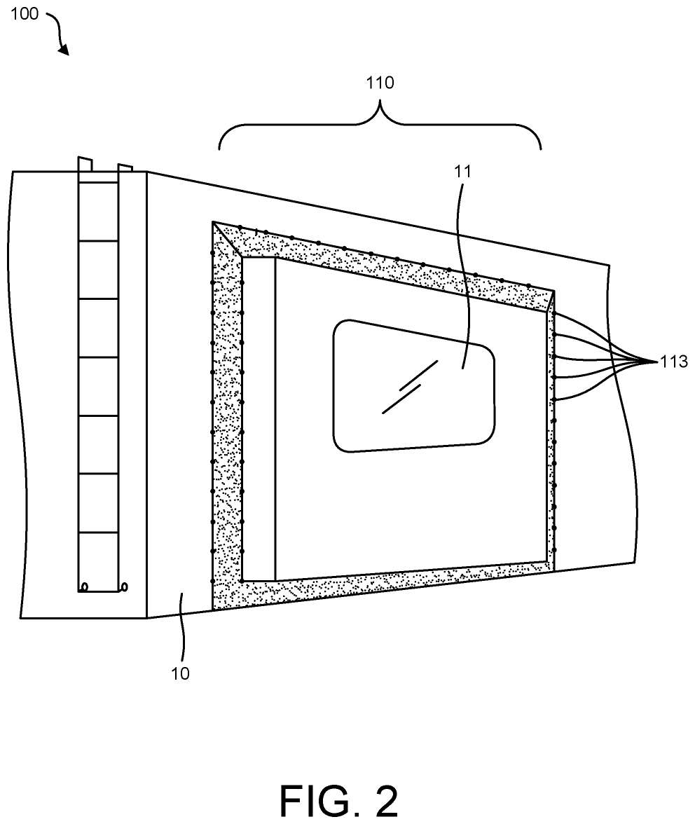

FIG. 2 illustrates a top view of a roof protector 130 as disposed on a top surface of the RV 10 in an extended position, according to an exemplary embodiment of the present general inventive concept.

The roof protector 130 may include a front guard 131, a spring-loaded roller 132, a roof-protection mat 133, at least one roof boot 134, a roof protector motor 135, a belt 136, and a plurality of fasteners 137.

The front guard 131 may be constructed from a strong, flexible material. For example, the front guard 131 may be constructed from neoprene, but is not limited thereto.

The front guard 131 may be of any predetermined size to substantially cover at least a portion of a front of the RV 10. As such, the front guard 131 may be a one-size fits all design. Alternatively, the front guard 131 may be constructed for specific sizes of the roof of the RV 10.

The roof protector 130 may be removably connected to at least a portion of a roof of the RV 10. The front guard 131 may be disposed within a first portion of the spring-loaded roller 132. The front guard 131 may be at least partially extended in a first vertical direction or a second vertical direction from a first position (i.e. retracted) to a second position (i.e. extended) to at least partially cover a portion of the front of the RV 10. Moreover, the spring-loaded roller 132 may rotate in a first direction (i.e. clockwise) or a second direction (i.e. counterclockwise) in response to the front guard 131 being at least partially extracted therefrom. Also, the front guard 131 may be at least partially retracted in the second vertical direction or the first vertical direction from the second position to the first position. As such, the spring-loaded roller 132 may rotate in the second direction or the first direction in response to the front guard 131 being at least partially retracted. Furthermore, the spring-loaded roller 132 may automatically retract due to a spring mechanism moving the front guard 131 back into the first portion of the spring-loaded roller 132.

The front guard 131 may protect the portion of the front of the RV 10 from inclement weather when the front guard 131 is at least partially extended away from the wall around the window 11, such as rain, snow, sleet, hail, etc., but is not limited thereto. Furthermore, the front guard 131 may insulate the interior portion of the RV 10 by preventing cold air and/or hot air from reaching the interior portion of the RV 10. Moreover, the front guard 131 may prevent UV radiation from reaching the interior portion of the RV 10.

The roof-protection mat 133 may be constructed from a strong, flexible material. For example, the roof-protection mat 133 may be constructed from neoprene, but is not limited thereto.

The roof-protection mat 133 may be of any predetermined size to substantially cover at least a portion of the roof of the RV 10. As such, the roof-protection mat 133 may be a one-size fits all design. Alternatively, the roof-protection mat 133 may be constructed for specific sizes of the roof of the RV 10.

The roof-protection may 133 may be disposed within a second portion of the spring-loaded roller 132. The roof-protection mat 133 may be at least partially extended in a first lateral direction or a second lateral direction from a first position (i.e. retracted) to a second position (i.e. extended) to at least partially cover a portion of the roof of the RV 10. Moreover, the spring-loaded roller 132 may rotate in the first direction or the second direction in response to the roof-protection mat 133 being at least partially extracted therefrom. Also, the roof-protection mat 133 may be at least partially retracted in the second lateral direction or the first lateral direction from the second position to the first position. As such, the spring-loaded roller 132 may rotate in the second direction or the first direction in response to the roof-protection mat 133 being at least partially retracted. Furthermore, the spring-loaded roller 132 may automatically retract due to the spring mechanism moving the roof-protection mat 133 back into the second portion of the spring-loaded roller 132.

The roof-protection mat 133 may protect the portion of the roof of the RV 10 from inclement weather, such as rain, snow, sleet, hail, etc., but is not limited thereto. Furthermore, the roof-protection mat 133 may insulate the interior portion of the RV 10 by preventing cold air and/or hot air from reaching the interior portion of the RV 10. Moreover, the roof-protection mat 133 may prevent UV radiation from reaching the interior portion of the RV 10.

The plurality of fasteners 137 may include a soldered joint, a glued joint, a screw, a nail, a bolt, a nut, a washer, and/or any combination thereof, but is not limited thereto.

The roof-protection mat 133 may be affixed and/or adhered to the roof of the RV 10 using the plurality of fasteners 137. As such, the roof-protection mat 133 may snugly fit the roof of the RV 10. Furthermore, there may be an overlap of the roof-protection mat 133 while the roof-protection mat 133 is connected to the roof of the RV 10. For example, the overlap may be between 3 to 6 inches, but is not limited thereto.

The at least one roof boot 134 may be removably connected to at least one of at least one air conditioning (AC) unit 12 and a skylight 13 of the RV 10. The at least one roof boot 134 may be secured using the plurality of fasteners 137. The at least one roof boot 134 may cover the at least one AC unit 12 and/or the skylight 13. As such, the at least one roof boot 134 may protect the at least one AC unit 12 and/or the skylight 13 from inclement weather, such as rain, snow, sleet, hail, etc., but is not limited thereto. Furthermore, the at least one roof boot 134 may insulate the at least one AC unit 12 and/or the skylight 13 by preventing cold air and/or hot air from reaching the interior portion of the RV 10. Moreover, the at least one roof boot 134 may prevent UV radiation from reaching the interior portion of the RV 10.

The control unit 140 may include an input unit 141, a display unit 142, a processor 143, a communication unit 144, and a storage unit 145, but is not limited thereto.

The input unit 141 may include a keyboard, a touchpad, a mouse, a trackball, a stylus, a voice recognition unit, a visual data reader, a camera, a wireless device reader, and a holographic input unit.

The display unit 142 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 142 may be combined with the input unit 141 to be a touch-screen.

The processor 143 (or central processing unit, CPU) may include electronic circuitry to carry out instructions of a computer program by performing basic arithmetic, logical, control and input/output (I/O) operations specified by the instructions. The processor 143 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 143 may also include a microprocessor and a microcontroller.

The communication unit 144 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 145 may include a random access memory (RAM), a read-only memory (ROM), a hard disk, a flash drive, a database connected to the Internet, cloud-based storage, Internet-based storage, or any other type of storage unit.

A user may input commands to the control unit 140 using the input unit 141 to control the slide-out cover 110 and/or the roof protector 130. Specifically, the user may enter a command using the input unit 141, such that the processor 143 may send a command to the slide-out cover motor 112 to begin rotating. The belt 113 may move the at least one rod 114 in the first lateral direction or the second lateral direction in response to a rotation of the slide-out cover motor 112. As such, the cover mat 111 may extend in response to movement of the at least one rod 114. Additionally, the user may enter another command using the input unit 141, such that the at least one rod 114 may move in the second lateral direction or the first lateral direction to retract the cover mat 111.

Also, the user may enter a command using the input unit 141, such that the processor 143 may send a command to the roof protector motor 135 to begin rotating. The belt 136 may rotate the spring-loaded roller 132 in the first direction or the second direction in response to a rotation of the roof protector motor 135. As such, the front guard 131 and/or the roof-protection mat 133 may extend in response to movement of the spring-loaded roller 132. Additionally, the user may enter another command using the input unit 141, such that the spring-loaded roller 132 may rotate in the second direction or the first direction to retract the front guard 131 and/or the roof-protection mat 133.

Furthermore, the user may view predetermined settings of the slide-out cover 110 and/or the roof protector 130 on the display unit 142 that are stored on the storage unit 145. The predetermined settings may be set by a manufacturer and/or programmed based on the user's preferences.

The sensor 150 may include a temperature sensor, a UV sensor, a precipitation sensor, etc., but is not limited thereto.

The user may also enter a command on the input unit 141, such that the processor 143 may monitor for at least one signal (i.e. an alert) from the sensor 150. In other words, the sensor 150 may detect at least one of a temperature level, a UV radiation level, and a precipitation level (collectively, a detected reading) and transmit the at least one signal to the processor 143. The processor 143 may compare the detected reading to a predetermined threshold stored in the storage unit 145. Thereafter, the processor may issue a command to the slide-out cover motor 112 and/or the roof protector motor 135 in response to the detected reading from the sensor 150 exceeding the predetermined threshold, such that the slide-out cover motor 112 and/or the roof protector motor 135 may perform any one of the actions described above. As such, the control unit 140 may operate automatically in response to the at least one signal from the sensor 150 based on the predetermined settings.

The user may use an external device 20 to remotely control the control unit 140.

The external device 30 may be a mobile phone, a laptop computer, a tablet computer, a desktop computer, a palm pilot, a smart watch, etc., but is not limited thereto, and may be any type of mobile device that connects to the Internet or any other type of network. In other words, the external device 30 may also be referenced as an apparatus 30, for at least the reason that the mobile device 30 may be movable or stationary, depending on a user's preference).

The external device 20 may include an input unit 21, display unit 22, a processor 23, a communication unit 24, and a storage unit 25.

The input unit 21 may include a keyboard, a touchpad, a mouse, a trackball, a stylus, a voice recognition unit, a visual data reader, a camera, a wireless device reader, and a holographic input unit.

The display unit 22 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 22 may be combined with the input unit 21 to be a touch-screen.

The processor 23 (or central processing unit, CPU) may include electronic circuitry to carry out instructions of a computer program by performing basic arithmetic, logical, control and input/output (I/O) operations specified by the instructions. The processor 23 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 23 may also include a microprocessor and a microcontroller.

The communication unit 24 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 25 may include a random access memory (RAM), a read-only memory (ROM), a hard disk, a flash drive, a database connected to the Internet, cloud-based storage, Internet-based storage, or any other type of storage unit.

The user may view the settings of the control unit 140 on the display unit 22 based on settings stored in the storage unit 25. The user may use the input unit 21 to select the settings of the control unit 140. Specifically, the processor 23 may send a command to the communication unit 24 in response to the user's input to the input unit 21. The communication unit 24 of the external device 20 may send a signal to the communication unit 144 of the control unit 140. Thereafter, the communication unit 144 of the control unit 140 may send the signal received from the external device 20 to the processor 143 of the control unit 140. As such, the processor 143 of the control unit 140 may send a command to the slide-out cover motor 112 and/or the roof protector motor 135 to change settings.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A slide-out cover, comprising:
a cover mat removably connected to a portion of a wall surrounding a window of a vehicle to at least partially expose the window in a first position and to at least partially cover the window in a second position; and
at least one rod to support the cover mat.

2. The slide-out cover of claim 1, wherein the cover mat insulates an interior portion of the vehicle by preventing at least one of cold air and hot air from reaching the interior portion of the vehicle.

3. The slide-out cover of claim 1, wherein the cover mat prevents UV radiation from reaching the interior portion of the vehicle.

4. A roof protector, comprising:
a spring-loaded roller removably connected to a portion of a roof of a vehicle; and
a roof-protection mat disposed within the spring-loaded roller to at least partially expose the roof in a first position and to at least partially cover the roof in a second position.

5. The roof protector of claim 4, further comprising:
a front guard disposed within the spring-loaded roller to at least partially expose the front of the vehicle in a first position and to at least partially cover a front of the vehicle in a second position.

6. The roof protector of claim 4, further comprising:
at least one roof boot to cover at least one of an AC unit and a skylight.

7. A vehicle protection system to protect a vehicle from weather and temperature, the vehicle protection system comprising:
a slide-out cover to at least partially expose the window in a first position and to at least partially cover a window of the vehicle in a second position;
a rain bag to collect and direct water away from the window; and
a roof protector to at least partially expose the roof in a first lateral position and to at least partially cover a roof in a second lateral position.

8. The vehicle protection system of claim 7, further comprising:
a control unit to control at least one of the slide-out cover and the roof protector.

9. The vehicle protection system of claim 8, wherein the slide-out cover comprises:
a slide-out cover motor to rotate in response to a command from the control unit, such that the slide-out cover moves in response to the rotation of slide-out cover motor.

10. The vehicle protection system of claim 8, wherein the roof protector comprises:
a roof protector motor to rotate in response to a command from the control unit, such that the roof protector moves in response to the rotation of the roof protector motor.

11. The vehicle protection system of claim 8, further comprising:
a sensor to detect a reading of at least one of a temperature level, a UV radiation level, and a precipitation level, such that the control unit compares the detected reading to a predetermined threshold.

12. The vehicle protection system of claim 11, wherein the control unit sends a command to the slide-out cover based on the comparison.

13. The vehicle protection system of claim 12, wherein the slide-out cover moves in response to the command from the control unit.

14. The vehicle protection system of claim 11, wherein the control unit sends another command to the roof protector based on the comparison.

15. The vehicle protection system of claim 14, wherein the roof protector moves in response to the another command from the control unit.

16. The vehicle protection system of claim 7, wherein the rain bag, comprises:
a water-collecting surface to collect and direct water away from a window of the vehicle; and
a drain hose disposed on a portion of the water-collecting surface to drain water from the water-collecting surface.
